(19) United States
(12) Patent Application Publication
(10) Pub. No.: US 2010/0198781 A1
(43) Pub. Date: Aug. 5, 2010

(54) PLC HAVING COMMUNICATION FUNCTION

(76) Inventors: Tsutomu Yuine, Tokyo (JP); Shigeharu Matsumoto, Tokyo (JP)

Correspondence Address: MCDERMOTT WILL & EMERY LLP, 600 13TH STREET, N.W., WASHINGTON, DC, 20005-3096, US

(21) Appl. No.: 12/601,737

(22) PCT Filed: May 23, 2008
(86) PCT No.: PCT/JP2008/001291

§ 371 Date: Nov. 24, 2009

(30) Foreign Application Priority Data
May 29, 2007 (JP) 2007-141754

(51) Int. Cl. G06F 13/14; G06F 17/30

(52) U.S. Cl. 707/609; 710/305; 707/E17.005; 707/E17.045

(57) ABSTRACT

A networking PLC core comprising a program for uniting a programmable logic controller function to a fourth transport layer and a fifth session layer in compliance with network communication specifications in an OSI reference network model embedded therein, and a single or plural ICs or modules for exclusive use which are configured to store, manage and execute the program.

### FIELD OF THE INVENTION

The present invention relates to a PLC system for connecting plural PLCs and devices through communication or a network in the technical field relevant to PLC (programmable logic controller) used to control machines and devices, an assembling plant, and the like.

### BACKGROUND OF THE INVENTION

For a current PLC system, there are many different-sized PLCs, such as micro PLC, compact PLC and mid-size PLC, in response to the size and functions of a required control mode. The type of serial communication and network adopted for connection also varies from one company to another. In the conventional network-based PLC system, the PLCs on the network merely operate to transfer data, and it is not possible to functionally distinguish one PLC from other PLCs. Further, it is difficult to perform the peer-to-peer data communication between the devices of each PLC control within the network. It is difficult to share PLC commands and data information (hereinafter, referred to as PLC information) between PLCs within the network, and it is not possible for one PLC to control other PLCs. Therefore, when PLCs themselves are improved and have advanced features, an application program related to the PLCs becomes complicated, and a large capacity is required, resulting in an increase in manufacturing and development costs and troubles. An embedded PLC product in which a PLC is configured as an IC for exclusive use such as ASIC or FPGA is already commercially available (see the Patent Document 1).

Patent Document 1: U.S. Pat. No. 6,857,110

### DISCLOSURE OF THE INVENTION

### Problem to be Solved by the Invention

The Applicant earnestly carried out various researches in view of the current circumstances of the PLC system mentioned above, and presents a networking PLC core in this specification. The networking PLC core is a specific-purpose chip which has the same shape as that of a conventional product. However, the networking PLC core is based on a novel logic scheme, in which such features as networking, PLC, data logging and relational database management (RDBM) are integrated and operated in collaboration with one another.

Since it was very difficult to achieve the integration and collaboration on the currently available PLC, the Applicant had to expend enormous efforts in the process of his researches. It was also difficult to share programs and data and execute master slave operations and time division multiplex operations among a single or plural PLCs and input/output devices, a motion controller and the like connected to a network.

The present invention provides a networking PLC core, a network PLC, and a network PLC system based on a novel concept and by solving problems concerning a PLC system having a higher functionality; a network system having a broader scale and multi-functionality; the adoption of a PLC having a multi-CPU modular configuration which realizes such a PLS system and such a network system; the adoption of variously different serial communications and networks; and the creation of a complicated program having a large volume and also by reducing costs of the PLC system to a large extent.

### Means for Solving the Problem

A networking PLC core claimed in Claim 1 of the present invention comprises a program for uniting a programmable logic controller function to a fourth transport layer and a fifth session layer, which are network communication specifications in an OSI reference network model, embedded therein; and a single or plural ICs or modules for exclusive use which are configured to store, manage and execute the program.

The “function” in the programmable logic controller function basically denotes command, address, program system, run logic system, and run system.

“Being United” means that the same command, address and program system, and the same run logic and run system are employed.

According to Claim 1 of the present invention, the PLC function is united to the conventional network function in the networking PLC core and consequently collaboration with other device or devices incorporated in the networking PLC core is made possible. As a result, the following effects are produced: an inexpensive PLC system can be easily built; control functions and a control dimension can be flexibly dealt with; a local communication between the connected devices can be established; and the whole process from manufacturing to abandoning can be tracked down and grasped.

In the networking PLC core claimed in Claim 2 of the present invention, a PLC basic logic command, a jump command, a sequence command, a timer command, and PLC-extended commands such as various function commands are embedded in order to carry out the programmable logic controller function.

The network PLC claimed in Claim 3 of the present invention has a stand-alone PLC configuration, comprising the networking PLC core, a memory, a power supply circuit, an input/output driver and a terminal.

In the network PLC system claimed in Claim 4 of the present invention, the single network PLC and a single or plural network connection devices are connected to the same network.

In the network PLC system claimed in Claim 5 of the present invention, the plural network PLCs and a single or plural network connection devices are connected to the same network.

In the network PLC system claimed in Claim 6 of the present invention, the network connection device is a device having at least one of functions of input/output drive, motion control, instrumentation control, temperature control and the like.

A network PLC system claimed in Claim 7 of the present invention comprises a memory for sharing data and programs with network connection devices mounted on the networking PLC core and/or the network PLC and other network connection devices, wherein the network PLC and these other network connection devices connected to the network share data-write and data-read using an application program of the network PLC.

In the network PLC and the network PLC system claimed in Claim 8 of the present invention, a relational database management system (RDBMS) for sharing, controlling and managing the data and programs of all of the network devices including the network PLC connected to the network is ported to the networking PLC core.

### Effect of the Invention

According to the networking PLC core, network PLC and network PLC system provided by the present invention, the conventional problems concerning the adoption of variously different serial communications and networks and the creation of any complicated large-volume program can be solved, costs and working steps for building a PLC system can be largely reduced, any type of PLC system ranging from a micro PLC system comprising a single network PLC to a mid-size or large-scale PLC system comprising plural network PLCs and plural network devices such as motion control, temperature control and sensor drive can be flexibly and easily built, and maintenance and repair operations can be simplified, which improves the reliability of the system.

### BRIEF DESCRIPTION OF THE DRAWINGS

FIG. 1A is a drawing illustrating a schematic constitution of a network PLC system according to the present invention.

FIG. 1B is a drawing illustrating a schematic constitution of a conventional network PLC system having a multi-CPU modular configuration.

FIG. 2A is a drawing illustrating schematic constitutions of a network PLC and the network PLC system.

FIG. 2B is a drawing illustrating a detailed constitution of a networking PLC core illustrated in FIG. 2A.

FIG. 3 is a drawing for describing a network function and a PLC function referring to an OSI network reference model.

FIG. 4 is a drawing illustrating an exemplified constitution of a network PLC system in which a common memory is provided.

FIG. 5 is a drawing illustrating an exemplified operation flow including retrieval, extraction, updating/computing and merger in which RDB is used.

### DESCRIPTION OF REFERENCE SYMBOLS

10-30 network PLC

10a networking PLC core

10a1 FPGA

10a2 CSP/CPU

10a3 external memory device

10b flash memory

10c power supply circuit

10d external IO driver

### BEST MODE FOR CARRYING OUT THE INVENTION

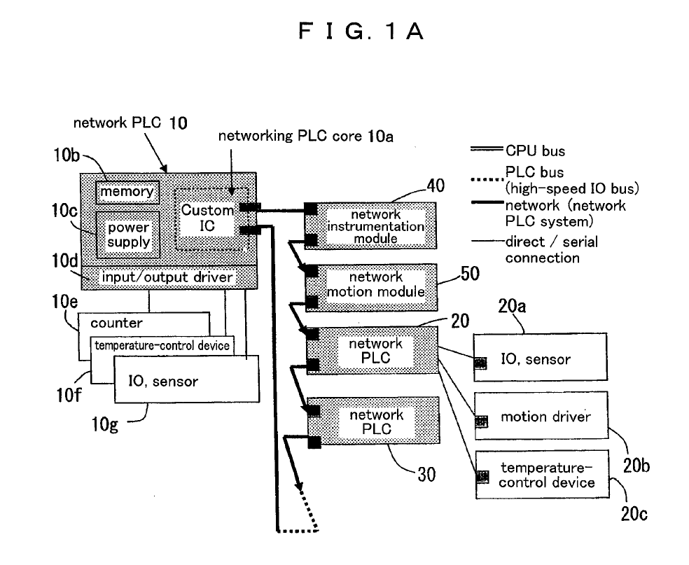

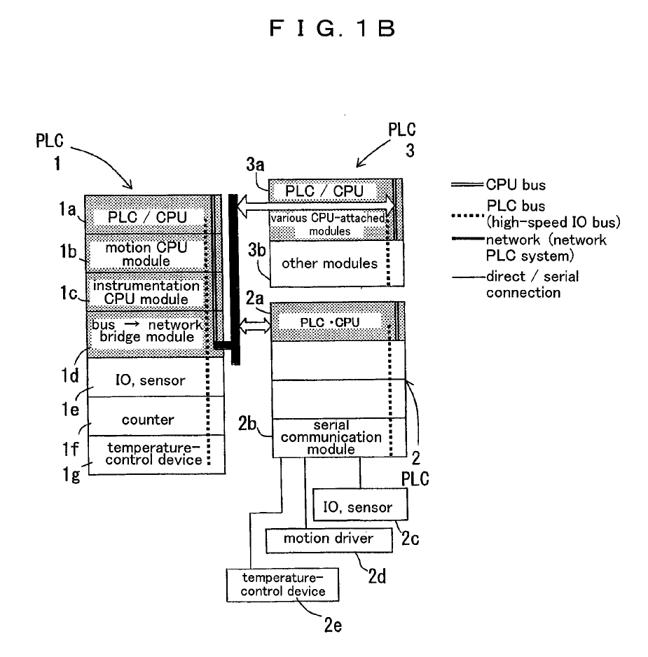

A simple description of a network PLC system according to the present invention is given below in comparison to a conventional PLC system in which multiple CPU modules are adopted. The network PLC system according to the present invention is illustrated in FIG. 1A, while the conventional PLC system having a multi-CPU modular configuration.

FIG. 1B is an illustration of an example in which three PLCs having a multiprocessor modular configuration are connected to one another through a network or serial communication, thereby constituting a sophisticated mid-size or large-scale PLC system.

A PLC 1 comprises plural CPU-embedded modules 1a-1d connected to one another by a CPU bus, and plural modules 1e-1g connected to a PLC bus.

A PLC 2 comprises a CPU-embedded module 2a and external devices 2c-2e by way of a serial communication module 2b, and is connected to the modules 2c-2e through the serial communication.

A PLC 3 comprises plural CPU-embedded modules 3a and 3b and plural modules 3c.

The PLC system illustrated in FIG. 1B has such a system configuration that can flexibly respond to a high functionality such as motion, instrumentation and remote monitor. However, the PLC system is disadvantageous in that: the PLCs and the system are expensive; an application program is complicated and has a large volume, since network connections with other PLCs are basically data transport, it is difficult to execute one PLC by distinguishing it from other PLCs connected to it via the network; it is difficult for the devices connected to the network to communicate with each other (On The Go—OTG: communication between devices); and others.

FIG. 1A is an illustration of the network PLC system according to the present invention. The network PLC system is a example which replaces the large-scale system illustrated in FIG. 1B.

In the network PLC system, three network PLCs 10-30, a network instrumentation module 40, and a network motion module 50 are connected to the same network. The network instrumentation module 40 and the network motion module 50 are connected to the same network that a networking PLC core 10a which is a custom IC in the network PLC 10 is connected to. The network PLC 10 comprises the networking core 10a, a memory 10b, a power supply 10c and an input/output driver 10d.

A counter 10e, a temperature-control device 10f and an input/output sensor 10g are connected to the input/output driver 10d of the networking PLC 10.

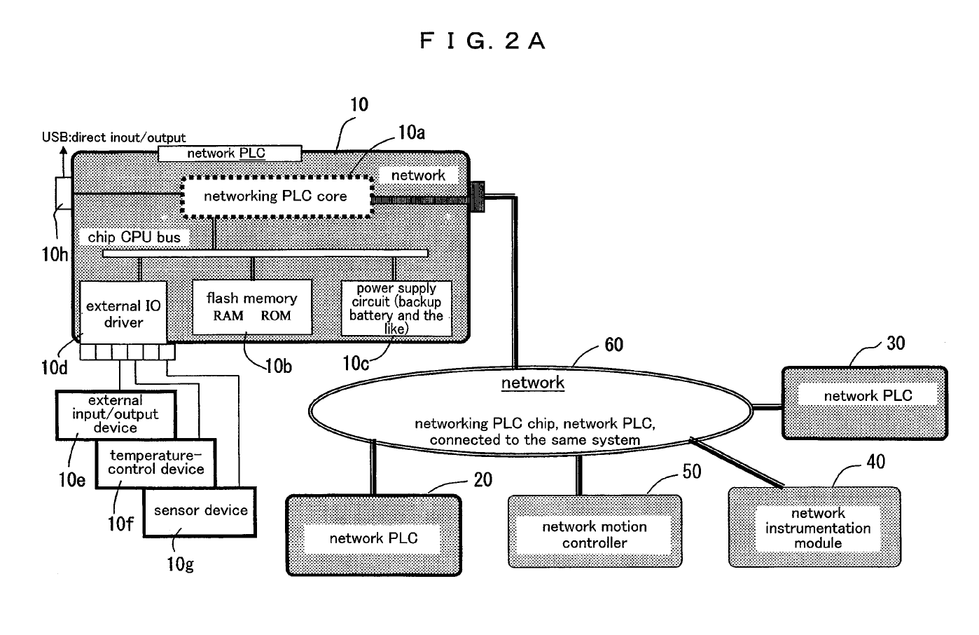

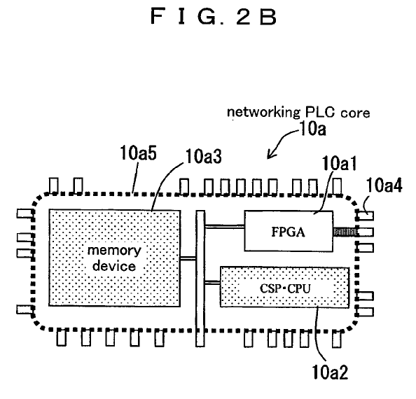

Below is described in detail a network PLC system according to a preferred embodiment of the present invention referring to drawings from FIG. 2 onward. FIG. 2A illustrates a schematic constitution of the network PLC system, and FIG. 2B illustrates a detailed constitution of the networking PLC core illustrated in FIG. 2A. In the network PLC system, plural network PLCs 10-30, a network motion controller 50 and a network instrumentation module 40 are connected to a network 60.

The network PLC 10 is a stand-alone PLC provided with minimum required functions. The network PLC 10 comprises a networking PLC core 10a, a flash memory 10b, a power supply circuit 10c and an external IO driver 10d. An external input/output device 10e, a temperature-control device 10f and a sensor device 10g are directly connected to the network PLC 10.

The networking PLC core 10a, which is a core structural element of the network PLC 10, comprises a field programmable gate array (hereinafter, referred to as FPGA) 10a1, chip-size package/CPU 10a2 (hereinafter, referred to as CSP/CPU), an external memory device 10a3, a terminal 10a4, a cabinet 10a5, a connector, and the like.

The FPGA 10a1 is in charge of drivers and interfaces in the first, second and third layers; transport in the fourth layer; and PLC logics in the fourth and fifth layers of the OSI reference model of the network.

The CSP/CPU 10a2 is in charge of storage, management and execution of a sequence command, a timer command, various functions and the like; control of a common memory; control of a relational database management system (RDBMS); and management and execution of inputs, outputs and the like, and packs an extended memory, a timer and the like, not shown, into a CSP (chip-size package).

The memory device 10a3 comprises a flash memory, ROM and RAM, and includes a common memory in the RAM.

The network PLC 10 is provided with a USB connector 10h to which a general-purpose personal computer, not shown, or the like is connected so that application programs such as a ladder program created by the general-purpose personal computer are directly downloaded therefrom and debugged. RS485 or IEEE1394 may be adopted as the connector.

The personal computer or the like is directly connected to the network 60 of the network PLC system and then the PLC application programs are downloaded into to each of the network PLCs 10-30. Thus constituted, the application programs of each of the network PLCs 10-30 can be dynamically debugged and simulated.

The network PLC system illustrated in FIG. 2A is constructed as a system by comprising three network PLCs 10-30, a network motion controller 40, a network instrumentation module 50, and plural devices 10e-10g directly connected to each of the network PLCs 10-30.

In the case where the network PLC 10 alone is connected to the network 60, the network PLC system is a system which can be programmed and executed as a virtual PLC.

In the case where the three network PLCs 10-30 are connected to the network 60 as illustrated in FIG. 2, a multi-operating system or the like is ported with respect to the networking PLC core (for example, 10a) of each of the network PLCs 10-30 (the networking PLC cores of the other network PLCs 20 and 30 are not shown). As a result, two network PLCs acting as slave can be operated in synchronization with one network PLC acting as master, and the network PLCs 10-30 can cooperatively perform time division multiplex operations and the like.

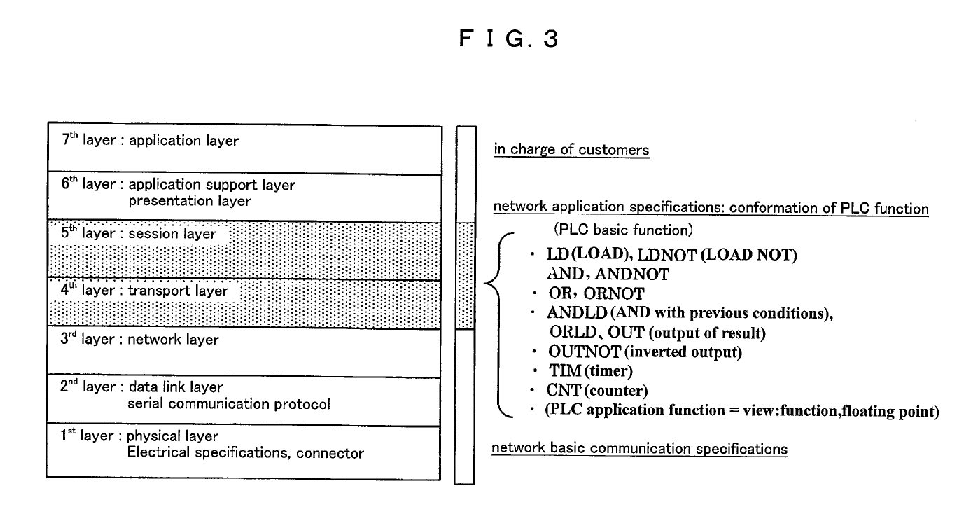

FIG. 3 is an illustration of a specification in which the PLC function is united to a network drive function and an interface function in the networking PLC core 10a and the network PLC 10 in which the networking PLC core 10a is incorporated. FIG. 3 is a drawing pursuant to the OSI reference model.

A first physical layer (electrical specifications, connector), a second data link layer (serial communication protocol) and a third network layer stay within the scope of standards of PROFIBUS, DeviceNet and USB which are widely used in the field of factory automation (FA). The first-third layers are pursuant to the basic communication specifications of the network.

In a fourth transport layer and a fifth session layer, data handled by upper application layers is interpreted, divided and modified so as to mange communication procedures and the like. The fourth and fifth layers are pursuant to network application specifications, to which the PLC function is united.

A sixth application support layer (or presentation layer) and a seventh application layer are application layers in charge of SQL language (relational data base language) and other applicable languages for controlling the relational-database (RDB) and also in charge of controlling a network PLC system configured according to user specifications. A sixth layer and a seventh layer are in charge of customers of the PLC system.

The PLC function is imported into the fourth transport layer and the fifth session layer, and 10 or more PLC basic logics as PLC basic functions such as LD (LOAD), LDNOT, AND, ANDNOT, OR, ORNOT, ANDLD, ORLD, OUT, TIM (TIMER) and CNT (COUNTER), and views, as PLC application functions, (names provide to relational algebra and relational logical expression as application functions) are executed with respect to data from upper application layers by the CSP/CPU 10a2.

Apart or all of sophisticated PLC logics such as floating point arithmetic, PID, and other functions as views are present in the fourth and fifth layers in the form of a table. The views are processed in collaboration with the CSP/CPU incorporated in the network PLC 10 and the external memory device 10a3.

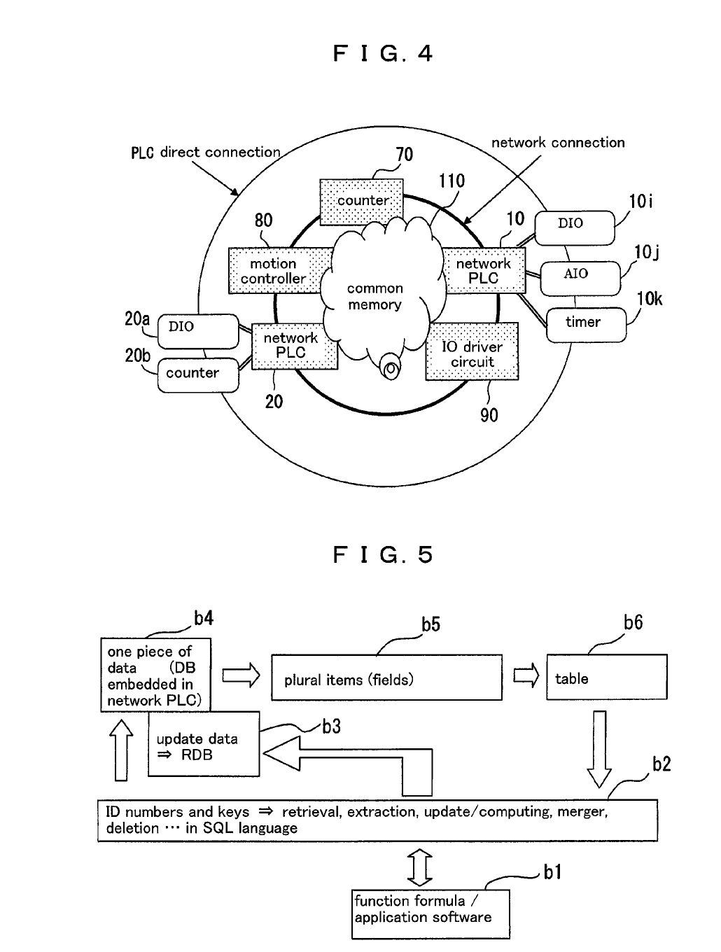

As illustrated in FIG. 4, the two network PLCs 10 and 20, a counter 70 which is a network input/output device, a motion controller 80, and an IO driver circuit 90 are connected to the network 60. Digital input/output modules (DIO) 10i and 20a, an analog input/output (AIO) module 10j, a timer 10k and a counter 20b are directly connected to the network PLC 10 and the network PLC 20. With all these structural elements additionally provided, the entire network PLC system is constructed. Each of the network PLCs 10 and 20 and the devices 70-90 connected to the network 60 comprises therein its networking PLC core, and its common memory 110 having a capacity necessary for each of them, and the like.

Data of the common memory 110 can be copied, written and read by each of the devices 10, 20 and 70-90 connected to the network 60. Programs are copied by the connected network PLCs 10 and 20 so that the master slave processing, synchronous processing, time division processing and the like are executed in coordination with one another by operating software and kernel software ported to each networking PLC core of the network PLCs 10 and 20.

With respect to all of the network PLCs 10 and 20 and network devices 70-90 connected to the network 60, memory addresses and data of the devices/modules controlled by the ladder program, such as the input/output devices/modules, counter devices/modules and instrumentation devices/modules, is hared by each network PLC to which the devices/modules are connected. The element connected via a PLC bus is called a module, while the element connected via a network or communication is called a device.

The data of the common memory 110 can be copied, read and written by each of the connected network devices 10, 20 and 70-90 cyclically one after another, or can be selectively copied, read and written by any of the network devices 10, 20 and 70-90 associated with the data. The data of the various modules directly connected to the PLC bus can also be shared.

FIG. 5 is an illustration of a data flow in which the relational database is used. In FIG. 5, a block b1 denotes function formulas and application software executed by the FPGA 10a1 and the CSP/CPU 10a2.

A block b2 denotes retrieval, extraction, update/computing, merger and deletion in the SQL language depending on ID numbers and keys.

A block b3 denotes RDB-compliant update data (RDB).

A block b4 denotes a block of data (stored in the RDB embedded in the network PLC).

A block b5 denotes a set of plural items (fields).

A block b6 denotes a RDB table which can be controlled by the SQL or the like.

The problems in the configuration of the networking PLC cores illustrated in FIGS. 2 and 4 in which the common memory 110 is used as a medium can be mostly solved by the configuration of the networking PLC core in which the relational database is used as a medium, and a micro PLC system or a small- or mid-size PLC system can be easily accomplished. The common memory is a hardware component and demands a memory capacity which is large enough to store the mounting volume of the PLC core, all of the data shared by all of the connected network devices, and data used exclusively for control operations. A memory capacity and a communication speed which are obtainable are largely restricted due to the type of the common memory, mounting area, costs and the like. In any PLC system in which the number of the devices to be connected is at least 10 and high-volume data processing or high-speed processing is demanded, the RDB is preferably used.

The hardware configurations of the networking PLC core, network PLC and networking PLC system in which the relational database (RDB) is used can be realized when RAMs, such as the common memory and the memories incorporated in the networking PLC core and the network PLC, are configured to perform high-speed processing and have a large capacity. Therefore, a software configuration of the RDBMS ported to a part of the fifth layer and the sixth layer in the OSI reference model illustrated in FIG. 3 becomes important. The networking PLC core and the network PLC configured as described below are provided: the physical independency of the data or programs, independency of the logical data, transaction processing, and distributed database are classified into three categories, which are the definition, operation and control, and then converted into a language; and the RDBMS of around 50K bytes in which the definition, operation and control of the PLC function are synchronized based on the SQL standardized by the ISO, JIS and ANSI (American National Standards Institute) is ported.

As described so far, the networking PLC core according to the present invention is constructed by: a single or plural application system integrated circuits (ASIC) such as a silicon on chip (SoC) or a system in package (SIP) in which all or a part of the PLC function, network function and data management function are compiled on a chip by means of a chip size package (CSP), a custom (exclusive) IC such as FPGA or a microminiaturized electronic circuit board; and PLC control software, network control software, data processing control software and the like ported to these components as firmware.

The PLC function, network function and data processing function described above belong to the fourth layer and the fifth layer of the OSI network reference model, and process data received from higher-level layers and the PLC programs in a coordinating manner.

The network PLC according to the present invention is a stand-alone PLC in which the networking PLC core thus described is incorporated. The network PLC is constructed by: power supply; the network; the ASIC or FPGA bus; input/output driver; backup battery; extended external memories; electronic circuit wiring such as analog digital converter; terminal; connector; cabinet; and the like.

The PLC application software executed by the network PLC comprises a connector which connects a program created by an external backup computer to USB or the like via serial communication so as to download the program into the networking PLC core and the network PLC and debug it.

The network PLC system according to the present invention comprises: a single or plural network PLCs connected to the same network that the networking PLC core is connected to; devices such as inputs and outputs having an network interface; sensor; motion control and instrumentation; and devices such as network connection hub and bridge and via-router device. In the case where a single network PLC is connected, the system application programs are programmable regardless of whether the network connection devices and the network PLC are connected through direct serial communication devices or parallel communication devices. In the case where plural network PLCs are connected, a network PLC system capable of executing multiplex processing such as distributed processing and master slave or time-division processing can be built.

In the case where the network PLC system is of a large scale, the network PLC used therein is preferably configured such that the operation speed and the capacity of the extended external memory thereof are increased, and an analog digital converter having advanced features is provided.

According to the present invention, multiplex processing such as distributed processing and master slave or time-division processing can be executed when the number of the network connections in the network PLC comprising therein the networking working PLC core, in which an inexpensively manufacturable chip or a module having the same shape as that of the chip is used, is increased depending on the dimension of the PLC control. As a result, the steps of creating the PLC application programs of the network PLC in which the network function and the PLC function are united can be reduced and the volume of the program is decreased. For the purpose of the unity between the network function and the PLC function, PLC basic commands and views (names of the functions of the PLC extended function) are set in the fourth and fifth layers of the OSI network reference model of the networking PLC core so they are operable in coordination.

According to a preferable mode of the present invention, the networking PLC core and the common memory are provided in all of the network connection device other than the network PLC connected to the network so that the data of the memories of all of the network connection devices can be written and read by any of these network devices. In other words, programs can be created and executed as if the network PLC system had one memory space. The communication such as the TCP in the connection-mode communication for transmitting stream data which previously secures a communication path may be used or the UDP in the data program communication for transmitting high-speed packet data which does not previously confirm a communication path may be used. The network devices can provide absolute addresses to their built-in networking PLC cores pursuant to the IPV6 or other applicable standard. In the case of programmable devices such as the network PLC and network motion control, an extended common memory of the common memory provided in the networking PLC core can be provided in the network devices. In order to improve a real-time performance in the communication with the network connection devices, the time-division multiplex communication or packet multiplex communication is adopted.

In a networking PLC core, a network PLC, a network PLC system according to another preferable mode of the present invention, network-compliant embedded RDBMS software having around 50 k bytes is ported to the networking PLC core to process the PLC programs and data.

The networking PLC core, network PLC and network PLC system which are characterized as described below can be provided: such a physical independency that allows the programs to be created and executed no matter which table of the RDBMS stores the data of the input/output device, sensor drive device and the like, and which of devices the relevant RDBMS belongs to; such a logical data independency that allows the result of the ladder program executed by modules such as the network-connected input/output, sensor and counter under the command of the network-connected network PLC to be newly stored as the RDB of all of the network-connected modules, so that the mid-size or large-scale PLC function can be executed regardless of the type of network; such transaction processing in which the programs of the plural network connection devices can reference and update the same data at the same time, and the network PLC system to which the plural network PLCs are connected is independently operable; the plural network PLCs connected to the network being able to coordinate with each other; master slave operations being able to be executed; and a distributed database function capable of realizing a mid-size or large-scale PLC system wherein the plural network PLC in which the networking PLC cores are used are connected.

1. A networking core comprising:
a single or plural ICs or modules for exclusive use in which a communication function based on a network having an OSI reference network model and a hierarchical protocol pursuant thereto are embedded, wherein
the single or the plural ICs or modules for exclusive use comprise the fourth layer, or a transport layer, and the fifth layer, or a session layer, which are network communication procedure specifications in the OSI reference network model,
a program for uniting commands, addresses, program system, run logic, and run system in a programmable logic controller function is embedded in the fourth layer, or the transport layer, and the fifth layer, or the session layer, and
the single or the plural ICs or modules for exclusive use store and manage the program, and store and execute a user application program.

2. The networking core as claimed in claim 1, wherein
a PLC basic logic command, a jump command, a sequence command, a timer command, and PLC-extended commands such as various function commands are embedded in order to carry out the programmable logic controller function.

3. A network PLC having a stand-alone PLC configuration, comprising the networking core claimed in claim 1 or 2, a memory, a power supply circuit, an input/output driver and a terminal.

4. A network PLC, wherein the single network PLC claimed in claim 3 and a single or plural network connection devices are connected to the same network.

5. A network PLC system, wherein plural the network PLCs claimed in claim 3 and a single or plural network connection devices are connected to the same network.

6. The network PLC system as claimed in claim 5, wherein the network connection device is a device having at least one of functions of input/output drive, motion control, instrumentation control, temperature control and the like.

7. The network PLC system as claimed in claim 5 or 6, comprising a memory for sharing data and programs with the network connection devices mounted on the networking PLC core and/or the network PLC and other network connection devices, wherein the network PLC and these other network connection devices connected to the network share data-write and data-read using an application program of the network PLC.

8. The network PLC system as claimed in any of claims 5-8, wherein
a relational database management system (RDBMS) for sharing, controlling and managing the data and programs of all of the network devices including the network PLC connected to the network is ported to the networking PLC core.
